(19) United States
(12) Patent Application Publication
(10) Pub. No.: US 2015/0142487 A1
(43) Pub. Date: May 21, 2015

(54) SYSTEMS AND METHODS FOR BENCHMARKING INTERNAL SUPPLIER DIVERSITY GOALS

(71) Applicant: Bank of America Corporation, Charlotte, NC (US)

(72) Inventors: Mary M. Webb Smith, Mount Holly, NC (US); Hilary L. Sharon, San Francisco, CA (US); Jeff C. Michaels, Tempe, AZ (US); Quinn J. Connell, College Park, PA (US)

(21) Appl. No.: 14/608,303

(22) Filed: Jan. 29, 2015

Related U.S. Application Data
(63) Continuation of application No. 13/200,616, filed on Sep. 27, 2011.

(51) Int. Cl. G06Q 10/06; G06Q 30/02

(52) U.S. Cl. CPC G06Q 10/0631; G06Q 30/0204
USPC 705/7.12

(57) ABSTRACT

Apparatus, methods and media for benchmarking diverse spend opportunities are provided. A method according to the invention preferably includes receiving financial data corresponding to entity diverse spend and financial data corresponding to total entity spend. The method may further include sorting the data corresponding to NAICS, UNSPSC or SIC code. The method may further include allocating an NAICS, UNSPSC or SIC code in the first column of a spreadsheet, allocating the data corresponding to entity diverse spend (“ds spend”) in the second column, allocating the data corresponding to entity total spend (“t spend”) in the third column; and place the following equation in each of the cells of the fourth column: =(ds spend/t spend)*100. The method may further include displaying a list of the percentages of entity diverse spend (“ped(s)”) for each NAICS, UNSPSC or SIC code based on the information in the fourth column.

### FIELD OF TECHNOLOGY

This application relates to supplier diversity and development (“SD & D”) objectives. More specifically, the application relates to setting internal goals for pre-determined spend categories in order to ensure growth in minority/women/disable based enterprises (“MWDBE”).

### BACKGROUND OF THE INVENTION

SD & D faces scrutiny from minority groups as well as women's interest groups. Furthermore, special attention is given to those areas experiencing spend decline and/or expanded opportunity. Therefore, it is important to monitor each individual minority group's spend to ensure one group's spend does not grow at the expense of another.

In addition to minority groups, the government on the one hand, and customers on the other hand, may require a diverse supply base. Finally, diversity spend stimulates growth of diverse companies, which, in turn, brings growth to the economy. For all the foregoing reasons, it is important for entities to focus on the needs of MWDBE.

One method for stimulating growth of MWDBE is by accessing through a central database referral system(s) that is dedicated to diverse and small supplier referrals. In addition, an entity may also invest in development of diverse suppliers.

It therefore would be desirable to provide apparatus, methods, and computer readable media for obtaining intelligence around diverse spend opportunities and categorizing these spend opportunities by commodity. For the purposes of this application, a commodity may be understood as a predetermined type of goods or services and a spend opportunity may be understood as an amount of funds that may be spent by on entity on a predetermined category of goods or services.

It would also be desirable to explore an entity's diverse spend by commodity and forecast optimal diverse spend goals.

### SUMMARY OF THE DISCLOSURE

Apparatus, methods and media for benchmarking an entity's diverse spend goals by category and/or commodity are provided. For the purpose of this application, one aspect of the term “benchmark” may be understood to refer to establishing, as a reference datum, the percentage of diverse companies that provide a predetermined commodity. Another aspect of benchmarking according to the invention may refer to comparing an observed datum to the reference datum to determine whether an opportunity to spend on diverse firms as a percentage of total spend on a commodity exists.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus that may be used in accordance with the principles of the invention;

FIG. 2 shows a chart of minority gross receipts;

FIG. 3 shows an illustrative flow diagram in accordance with the principles of the invention; and

FIG. 4 shows another illustrative flow diagram in accordance with the principles of the invention.

### DETAILED DESCRIPTION OF THE INVENTION

Apparatus, methods and media are provided for providing a diverse spend opportunities benchmark indicator. The scope of the apparatus, methods and media of the invention are directed to diverse spend opportunities in all of an entity commodities and/or categories. In one embodiment of the invention, the categories may be assigned based on a classification code, such as the North American Industry Classification System, The United Nations Standard Products and Services Code, or United States Department of Labor Standard Industry Classification Code (“NAICS, UNSPSC OR SIC”). Each of these standard may be used in classifying business establishments for the purpose of collecting, analyzing, and publishing statistical data related to the U.S. Business Economy. A more specific focus of this invention are MWDBE suppliers.

Some embodiments of the invention may derive commodity-specific (according to the NAICS, UNSPSC OR SIC classification code) diversity spend results for an entity as a portion of an entity's total commodity spend.

Certain embodiments may analyze industry-wide data for a country, such as the United States, that fall under specified NAICS, UNSPSC OR SIC codes.

Some embodiments may interpret the data in order to determine possible gaps, such as underpaid and/or overspend, for each commodity selected.

In response to the data interpretation, certain embodiments of the invention may make recommendations regarding where business opportunities exist based on the data.

An additional aspect of the invention may relate to documenting methodology behind the data interpretation in order to repeat the methodology for analyzing and interpreting data for other commodities, where appropriate.

Yet another aspect of the invention may relate to using gap information for indexing new business opportunity(s).

For example, a financial institution may lend money to small businesses. Typically, the institution assesses the loan applications based, at least in part, on the strength of the underlying business. The strength of the business may be based, at least in part, on the future prospects for success of the business.

In some embodiments of the invention, benchmarking diverse spend opportunities to obtain gap information regarding a good or service providing the business may clarify the future prospects for success of the business.

In a first embodiment, a financial institution may use gap information to assess whether a diverse business provides a good and/or service that is underspent—e.g., where the ratio of the quantity of diverse suppliers to the quantity of total suppliers is less than some standardized government requirement. Such a government requirement may require that 10% of all suppliers in a certain industry have to be diverse. In such a circumstance, the financial institution may improve the assessment of the diverse business based on its favorable disposition within an underspent industry.

In certain instances, such a requirement may be offset by the entity by using diverse suppliers indirectly, as follows. For example, a government may require a financial institution to use 10% diverse information technology suppliers. However, the financial institution may only directly use 8% diverse information technology suppliers. Accordingly, the financial institution is 2% short of the government requirement. In such an instance, the 2% shortfall may be offset by at least some of the non-diverse information technology suppliers used by the financial institution agreeing to sub-contract a portion of the work they receive from the financial institution to a diverse sub-contractor, or to direct at least a portion of the work to a diverse entity.

As such, the financial institution can make up the 2% shortfall by selecting the non-diverse information technology suppliers such that the non-diverse information technology suppliers sub-contract at least a minimum amount of the work to diverse sub-contractors.

In a second embodiment, which may be embodied in a second circumstance, the financial institution may improve the assessment of the diverse business based on its favorable disposition within an underspent industry.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

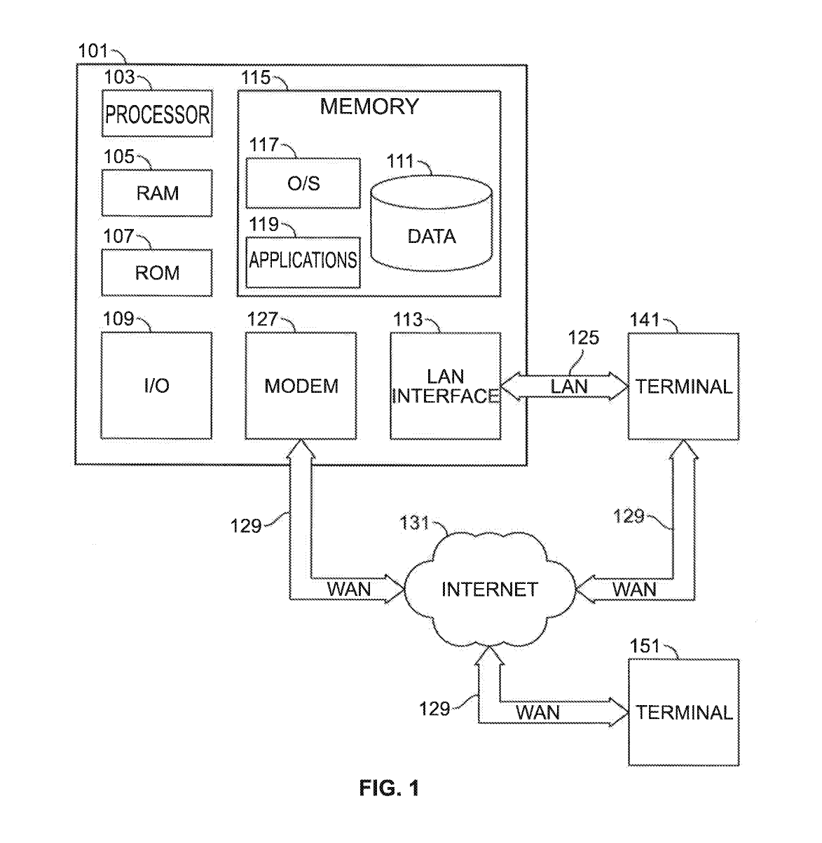

FIG. 1 is a block diagram that illustrates a generic computing device 101 (alternatively referred to herein as a “server”) that may be used in accordance with the principles of the invention. Server 101 may be included in any suitable apparatus that is shown or described herein. Server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information.

Any information described above in connection with database 121, and any other suitable information, may be stored in memory 125.

One or more of applications 119 may include one or more algorithms that may be used to process financial data, receive from a user an instruction, and/or perform any other suitable tasks related to benchmarking of diverse spend opportunities.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

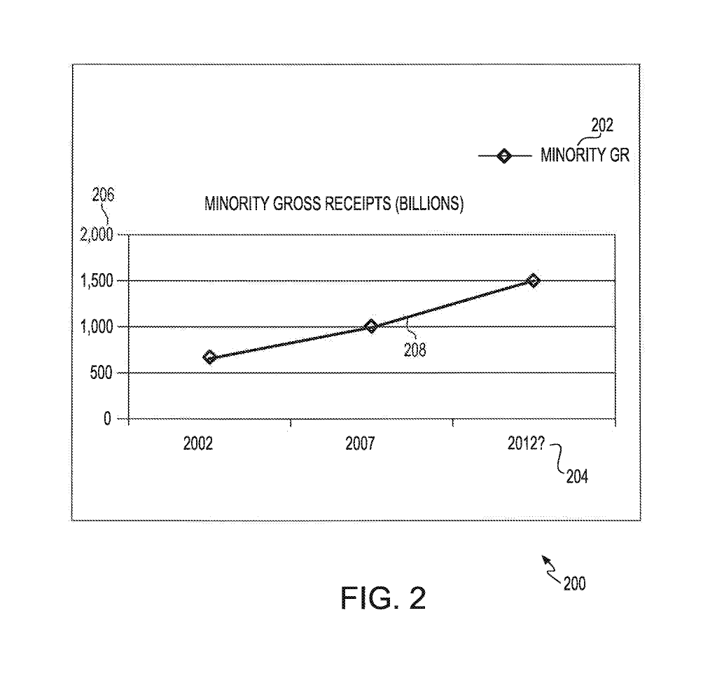

FIGS. 2-4 show illustrative aspects of the invention.

For the illustrative aspects of the invention, some, all or none of the following assumptions and/or facts may be relied on. Minority revenue numbers are increasing dramatically. Increasing gross receipts have created an increase in diverse spend opportunity. The ability to recognize this diverse spend opportunity, preferably as broken down by commodity, is important in order to target specific diverse spend gaps. Benchmarking diverse spend opportunities against entity spend gaps enables an entity to set appropriate future goals.

FIG. 2 shows a statistical analysis 200 of actual minority firms' gross receipts 202 (in billions) from 2002 to 2007. FIG. 2 also shows a projection of where minority businesses gross receipts would fall in 2012 if the growth between 2007 and 2012 equals the growth between 2002 and 2007.

The x-axis 204 in FIG. 2 represents the calendar year. The y-axis in FIG. 2 represents billions of dollars of gross receipts. The first half of the charted path 208 is based on actual numbers while the second half is projected. The actual data supporting the first half of path 208 was provided by the Minority Business Development Association.

For any given entity, diverse spend may account for a substantial percentage—e.g., 10-30% or even more—of an entity's total spend. The diverse spend may also be broken down into direct diverse spend—i.e., spend that goes directly to minority-owned firms—and indirect diverse spend—i.e., entity funds that pass through a non-minority-owned firm but are earmarked for a sub-contract(s) with a diverse firm(s).

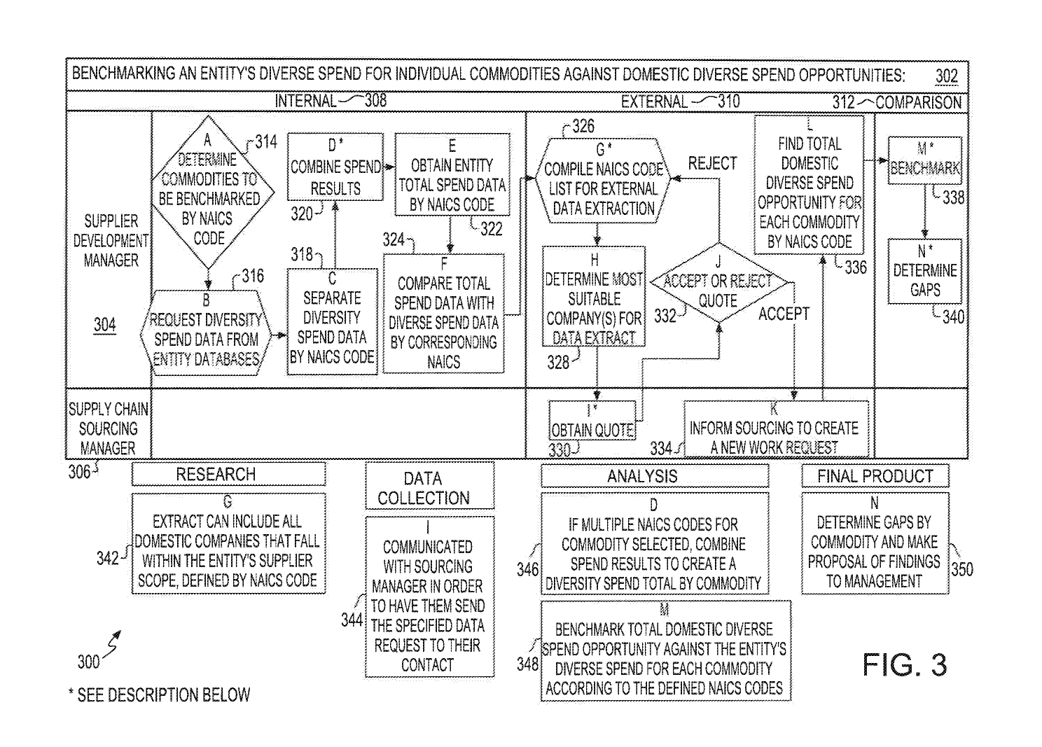

FIG. 3 shows a flow diagram that illustrates one methodology, according to the invention, for benchmarking an entity's diverse spend for individual commodities against exemplary domestic diverse spend opportunities, 302. The supplier development manager is shown at 304. He or she preferably reviews the operation of systems and methods for benchmarking according to the invention.

The internal aspects of these systems and methods are indicated at 308. The internal aspects relate to the portions of the process that may be performed solely by the entity actually undertaking the diverse spend.

The external aspects of these systems and methods are indicated at 310. Such external aspects may relate to the portions of the process that may involve entities other than the entity actually undertaking the diverse spend.

Internal data processing may initiate at A, wherein the method determines commodities to be benchmarked by NAICS, UNSPSC OR SIC (shown in the drawings as NAICS code for the sake of brevity) code, 314. At 316, the method requests diversity spend data from the entity database.

Step 318 shows separating the diversity spend data by NAICS, UNSPSC OR SIC code. The output from step 318 preferably includes segregated diversity spend in various NAICS, UNSPSC OR SIC-determined categories.

Step 320 shows combining diversity spend results, as set forth in greater detail in step 346. Specifically, the combination of diversity spend results is implemented such that, if multiple NAICS, UNSPSC OR SIC codes exist for a selected commodity, then the method may optionally require combining the spend results for the different NAICS, UNSPSC OR SIC codes to create a diversity spend total by commodity.

Step 322 shows using the output from step 320 to obtain entity total spend data. Where possible, the spend data is preferably separated by the NAICS, UNSPSC OR SIC code. Further, step 324 shows comparing total entity spend data with diverse spend data for each corresponding NAICS, UNSPSC OR SIC code.

Step 326, which preferably occurs in the external 310 area—receives the output of step 324 and compiles an NAICS code list for external data extraction—i.e., retrieval of selected information from a source external to the entity. The extract, as shown in step 342, can include all domestic companies that fall within the entity's supplier scope, as defined by the NAICS, UNSPSC OR SIC code.

The method may then, preferably, determine the most suitable company(s) for performing the data extract, as shown in step 328. Thereafter, the entity may obtain a quote from the data extraction company, as shown in 330. The quote may preferably be communicated to the sourcing manager. The sourcing manager can then send the specified data request to the data extraction company, as shown in 344.

At 332, the entity may accept or reject a quote from the data extraction company. If the quote is rejected, then the process loops back to step 326. If the quote is accepted, then the process continues to step 334. At 334, the entity instructs its sourcing manager to create a new work request for the data extraction company.

At step 336, the data extraction company preferably extracts the total domestic diverse spend opportunity for each commodity by NAICS, UNSPSC OR SIC code.

Preferably thereafter, the method may benchmark 338 the diversity spend. Specifically, and as shown at step 348, benchmarking may include benchmarking the total domestic diverse spend opportunity against the entity's diverse spend for each commodity. Such benchmarking may include benchmarking the entity's diverse spend percentage for each commodity against the total domestic diverse spend percentage opportunity against according to the defined NAICS, UNSPSC OR SIC codes.

Preferably any gaps between the entity's diverse spend percentage for each commodity and the total domestic diverse spend percentage may include underspend on a particular commodity and/or overspend on a particular commodity. At step 340, the method includes determining gaps. As shown in 350, the method may preferably determine gaps according to each commodity and may propose findings regarding appropriate approaches to such determined gaps.

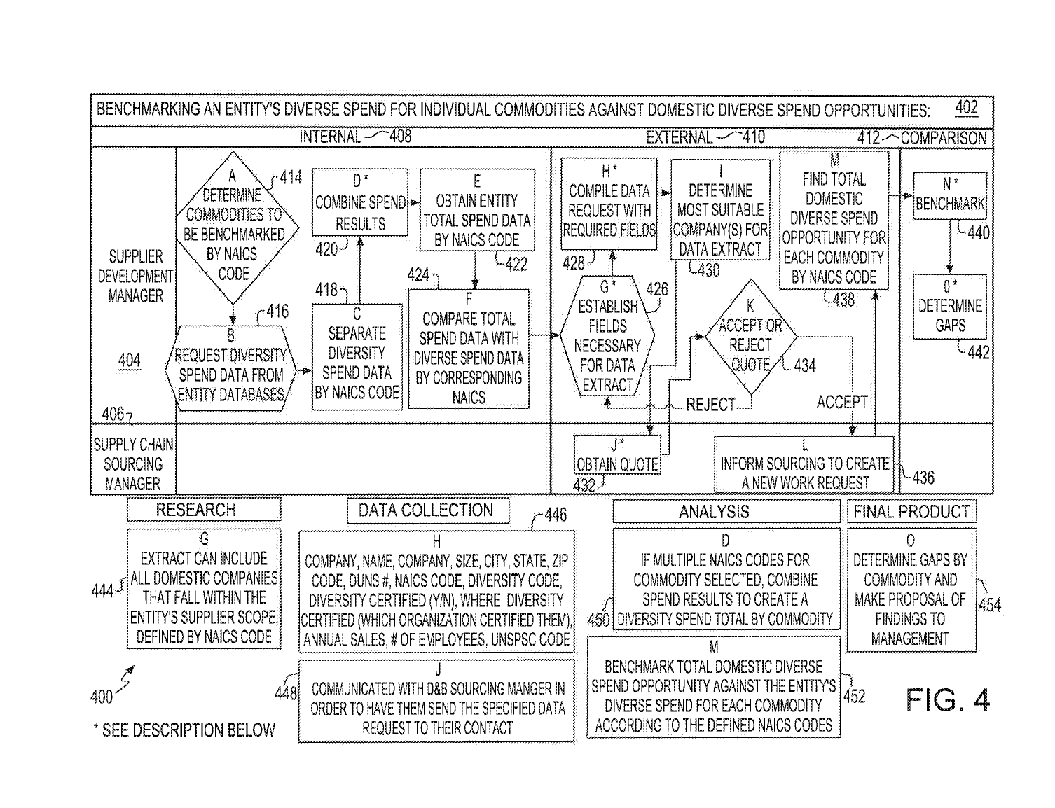

FIG. 4 shows a method similar to the method shown in FIG. 3. For brevity's sake, the steps that are the same in FIGS. 3 and 4 have not been described with respect to FIG. 4.

Notable differences between FIGS. 3 and 4 are found in steps 426 and 428, and corresponding informational box 452. Step 426 shows establishing fields necessary for a data extract according to the invention. Step 428 shows compiling data requests in accordance with the required fields by step 426. Informational box 452 shows a group of fields, preferably associated with suppliers, that may be considered required fields for a data extract. Such fields include company name, city, state, zip code, DUNS NO. (data universal numbering system), NAICS, UNSPSC OR SIC code, diversity code, diversity certified (y/n), where diversity certified (which organization certified them), annual sales, number of employees, UNSPSC code (The United Nations Standard Products and Services Code), etc.

The foregoing are possible methods for implementing benchmarking according to the invention. In short, systems and methods according to the invention may relate to deconstructing industry specific diverse spend opportunities. The first step in such deconstruction is targeting NAICS, UNSPSC OR SIC codes that correspond to a selected commodity. The next step is separating diverse providers of the commodity from non-diverse providers of the commodity. The deconstructing also may require computing annual sales for all diverse companies, and then deriving establishing a percent of total industry wide annual sales. Finally, the deconstructing may compare an entity's diverse spend with respect to the percent of diverse spend opportunity among total industry wide annual sales.

The aforementioned deconstruction may be expressed, at least in part, in the following equations:

diverse spend opportunity (“dso”)=opportunity to spend on diverse firms as a percentage of total spend on a commodity

dso(%)=(diverse annual sales/total annual sales)×100%

% of companies that are diverse (“dc”)(%)=percentage of diverse companies that provide a predetermined commodity

dc(%)=(# of diverse companies/total # of companies)×100

The paragraphs that follow set forth, in greater detail, possible analysis and methods, according to the invention, for use in providing industry-specific diverse spend opportunities.

First, the analysis may require gathering two separate data sets. One data set lists entity diverse spend by NAICS, UNSPSC OR SIC code and one lists total entity spend by NAICS, UNSPSC OR SIC code.

In each of these data sets, the analysis may further require creating a corresponding pivot table using Microsoft Excel™, manufactured by Microsoft of Redmond, Wash., or some other suitable equivalent of a pivot table. A pivot table displays the data contained in a column, row, or other suitable area (referred to collectively hereinafter as a “column”) of an Excel list (database) by means of subtotals (or other calculations) that are defined by another column in the same list. A pivot table summarizes data into a compact format, finds relationships within the data that may otherwise be hard to determine, and organizes data into a format that is easy to chart.

Using the pivot tables, the analysis sorts data so that NAICS, UNSPSC OR SIC codes can be aligned according to annual spend, or according to some other suitable spending period.

Then, in one preferred embodiment, the analysis lists and sorts values from pivot tables, preferably in a separate spreadsheet, into the following columns. NAICS, UNSPSC OR SIC (Column B); Diverse spend (Column C); and total spend (Column D).

Using numbers from the spreadsheet, the analysis calculates diverse spend/total spend percentages. Diverse spend values in the numerator and total spend values in the denominator may be used to calculate diverse spend percentages for each NAICS, UNSPSC OR SIC code. This formula, or other suitably similar formula, may be entered in Column E as =(D#/C#). The # is contingent on the row that the values are in. As such, one embodiment of diverse spend percentage calculations for each NAICS, UNSPSC OR SIC code has been shown and described.

Using the same, or similar pivot tables, the analysis may also sort data so that NAICS, UNSPSC OR SIC codes are aligned with number of suppliers, as opposed to diverse spend.

The analysis lists and sorts the number of supplier values taken from the pivot tables in the columns. Column F, for example, may list the total # of diverse suppliers per NAICS, UNSPSC OR SIC code and Column G lists the total # of suppliers per NAICS, UNSPSC OR SIC code.

Using values from the spreadsheet, diverse supplier count percentages can be calculated using the following exemplary spreadsheet arrangement. The formula entered in Column H is =(G#/F#) in each row. The # is contingent on the row that the values are in. Diverse supplier count percentage calculations for each NAICS, UNSPSC OR SIC code are now preferably complete.

After external data is received, spend opportunity and supplier count opportunity can be calculated. These opportunities are based on the diverse spend percentage and diverse supplier count percentage of the entire industry for each NAICS, UNSPSC OR SIC. Preferably, the aforementioned steps relating to the internal entity statistics can be used to compare this percentage with to the external data.

When these percentages for each NAICS, UNSPSC OR SIC have been calculated, they may be entered into the spreadsheet described above in Column I for diverse spend opportunity and Column K for diverse supplier opportunity.

Thereafter, the analysis may be used to measure gaps between entity diverse spend and external diverse spend opportunities. To calculate the gaps, subtraction may be used. Specifically, in Column J of the exemplary spreadsheet arrangement, the diverse spend gap is calculated using the formula=E#−I#. Column L is where the diverse supplier gap is calculated using the formula=H#−K#. The numbers should correspond with the row # in which they are located.

Thus, apparatus and methods for benchmarking diverse spend opportunities have been provided. Persons skilled in the art will appreciate that the present invention can be practiced by other than the described embodiments, which are presented for purposes of illustration rather than of limitation. The present invention is limited only by the claims that follow.

What is claimed is:

1. Apparatus for benchmarking diverse spend opportunities, the apparatus comprising:
a receiver module including hardware that is configured to:
receive financial data comprising entity diverse spend; and
receive financial data comprising total entity spend;
a processor module including hardware that is configured to:
sort the data comprising entity diverse spend by the North American Industry Classification System, United Nations Standard Products and Services Code, or United States Department
of Labor Standard Industry Classification Code (“NAICS, UNSPSC or SIC code”);
sort the data comprising total entity spend by NAICS, UNSPSC or SIC code;
determine whether the entity diverse spend for a single commodity corresponds to more than one NAIC NAICS code, more than one UNSPSC code, or more than one SIC code, and combine the entity diverse spend for the corresponding more than one NAICS code, more than one UNSPSC code, or more than one SIC code to obtain a diverse spend total by commodity for each entity diverse spend for a single commodity comprising more than one NAICS code, more than one UNSPSC code or more than one SIC code;
allocate NAICS, UNSPSC or SIC codes in a first column of a spreadsheet, allocating the commodity name in the first column for each diverse spend total by commodity;
allocate the data comprising entity diverse spend (“ds spend”) in a second column of the spreadsheet;
allocate the data comprising entity total spend (“t spend”) in a third column of a spreadsheet; and
place the following equation in a fourth column of a spreadsheet:
=(ds spend/t spend)*100
an output device that is configured to display a list of the percentages of entity diverse spend (“ped(s)”) for each NAICS, UNSPSC or SIC code for each allocated commodity name based on the information in the fourth column.

2. The apparatus of claim 1, wherein the receiver is further configured to receive a percentage of available diverse suppliers (“pad(s)”) with respect to the total number of suppliers corresponding to each NAICS, UNSPSC or SIC code.

3. The apparatus of claim 2, wherein the processor is further configured to compare at least one of the ped(s) to the corresponding pad(s).

4. The apparatus of claim 3, wherein the output device is further configured to provide gap information in response to the comparison of the at least one ped(s) to the corresponding pad(s).
